(19) United States
(12) Patent Application Publication
(10) Pub. No.: US 2022/0158500 A1
(43) Pub. Date: May 19, 2022

(54) ELEVATOR

(71) Applicant: Mitsubishi Electric Corporation, Tokyo (JP)

(72) Inventors: Hirohisa KUWANO, Tokyo (JP); Tomokazu SAKASHITA, Tokyo (JP); Miyuki TAKESHITA, Tokyo (JP); Hidehito YOSHIDA, Tokyo (JP); Mariko SHIOZAKI, Tokyo (JP); Takuya MIURA, Tokyo (JP)

(73) Assignee: Mitsubishi Electric Corporation, Tokyo (JP)

(21) Appl. No.: 17/438,937

(22) PCT Filed: Apr. 26, 2019
(86) PCT No.: PCT/JP2019/017888

§ 371 Date: Sep. 14, 2021

(51) Int. Cl. H02J 50/40; H02J 50/12; H02J 50/70; H02J 50/80; B66B 1/06; B66B 5/02

(52) U.S. Cl. CPC H02J 50/402; H02J 50/12; B66B 5/02; H02J 50/80; B66B 1/06; H02J 50/70

(57) ABSTRACT

An elevator includes a plurality of power transmission/reception devices each including: a power transmission coil connected to a main power supply; a power reception coil for receiving power transmitted from the power transmission coil and supplying power to a load; and an inverter which is provided between the main power supply and the power transmission coil, and which converts power supplied from the main power supply, to power having a predetermined frequency, and supplies the power to the power transmission coil, wherein the plurality of power transmission/reception devices are connected in parallel between the main power supply and the load. Since the inverters are individually connected to the power transmission coils, it is possible to efficiently supply power to the load even when using some of the power transmission coils.

### TECHNICAL FIELD

The present invention relates to a wireless power supply system that transmits power in a contactless manner, and an elevator provided with a wireless power supply system.

### BACKGROUND ART

There is known a wireless power supply system that supplies AC power to a power transmission coil and transmits power to a power reception coil located at a position separate from the power transmission coil. For example, a wireless power supply system in Patent Document 1 below includes a plurality of power transmission coils and supplies power only to the power transmission coil directly opposed to a power reception coil, to transmit power.

### CITATION LIST

### Patent Document

Patent Document 1: Japanese Laid-Open Patent Publication No. 2015-19551

### SUMMARY OF THE INVENTION

### Problems to be Solved by the Invention

The above wireless power supply system in Patent Document 1 has one inverter for supplying power to the plurality of power transmission coils, and the same inverter is used even in a case of transmitting power using some of the power transmission coils. However, such an inverter is normally designed so that power transmission efficiency (ratio between power outputted from a main power supply and power inputted to a load) of the wireless power supply system is maximized when specific power (e.g., rated power) is transmitted. Therefore, there is a problem that power transmission efficiency is reduced when power (e.g., power smaller than the rated power) different from the specific power is transmitted.

In addition, the same problem arises also in a case of providing the wireless power supply system in Patent Document 1 to an elevator and supplying power to the elevator.

The present invention has been made to solve the above problem, and an object of the present invention is to provide a wireless power supply system capable of efficiently transmitting power even in a case of transmitting power using some of coils, and an elevator provided with the wireless power supply system.

### Solution to the Problems

A wireless power supply system according to the present invention includes a plurality of power transmission/reception devices, the power transmission/reception devices each including: a power transmission coil connected to a main power supply; a power reception coil for receiving power transmitted from the power transmission coil and supplying power to a load; and an inverter which is provided between the main power supply and the power transmission coil, and which converts power supplied from the main power supply, to power having a predetermined frequency, and supplies the power to the power transmission coil, wherein the plurality of power transmission/reception devices are connected in parallel between the main power supply and the load.

An elevator according to the present invention includes: a car; a hoistway through which the car moves up/down; and the wireless power supply system, wherein the wireless power supply system is provided so that a plurality of the power reception coils provided to the car and a plurality of the power transmission coils provided to the hoistway are opposed to each other at a stop position of the car.

### Effect of the Invention

In the wireless power supply system and the elevator according to the present invention, since the inverters are individually connected to the power transmission coils, it is possible to efficiently supply power to the load even when using some of the power transmission coils.

### BRIEF DESCRIPTION OF THE DRAWINGS

FIG. 1 is a block diagram showing the configuration of a wireless power supply system according to embodiment 1 of the present invention.

FIG. 2 is a schematic diagram showing the configurations of power transmission coils and power reception coils of the wireless power supply system according to embodiment 1 of the present invention.

FIG. 3 is a graph showing the relationship between transmission power and power transmission efficiency of the wireless power supply system.

FIG. 4 is a block diagram showing the configurations of a control unit and communication units of the wireless power supply system according to embodiment 1 of the present invention.

FIG. 5 is a flowchart showing a process for performing power transmission in the wireless power supply system according to embodiment 1 of the present invention.

FIG. 6 is a block diagram showing the configuration of a wireless power supply system according to embodiment 2 of the present invention.

FIG. 7 is a flowchart showing a process for performing abnormality detection for a power transmission device of the wireless power supply system according to embodiment 2 of the present invention.

FIG. 8 is a block diagram showing the configuration of an elevator according to embodiment 3 of the present invention.

FIG. 9 is a schematic diagram showing a wireless power supply system provided to the elevator according to embodiment 3 of the present invention.

FIG. 10 is a block diagram showing the configuration of a wireless power supply system according to a modification of embodiments 1 to 3 of the present invention.

FIG. 11 is a schematic diagram showing power transmission coils and power reception coils of the wireless power supply system according to a modification of embodiments 1 to 3 of the present invention.

### DESCRIPTION OF EMBODIMENTS

Hereinafter, embodiments of the present invention will be described with reference to the drawings. In the drawings, the same reference characters denote the same or corresponding parts.

### Embodiment 1

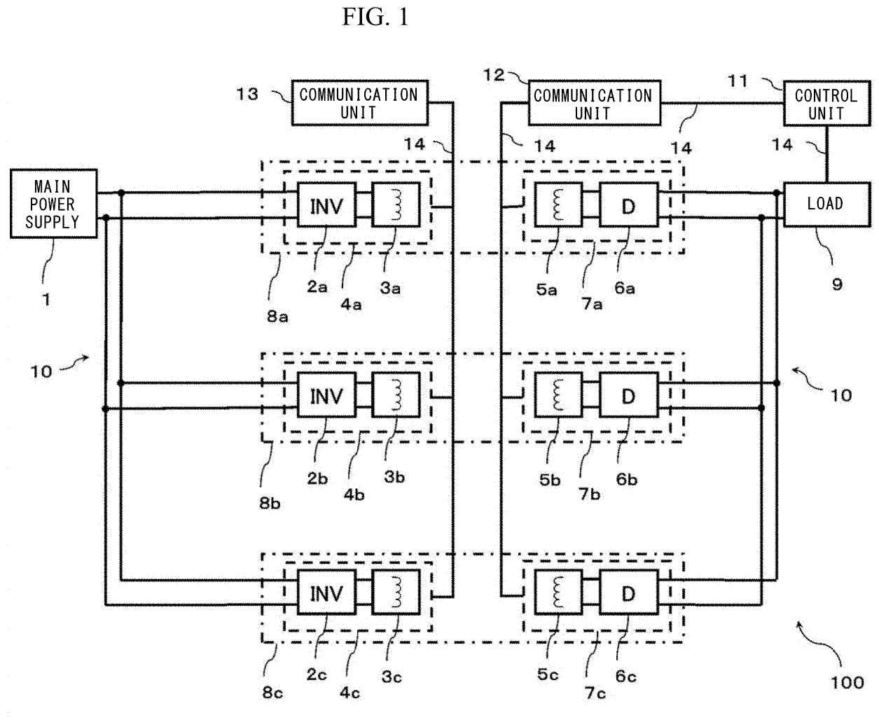

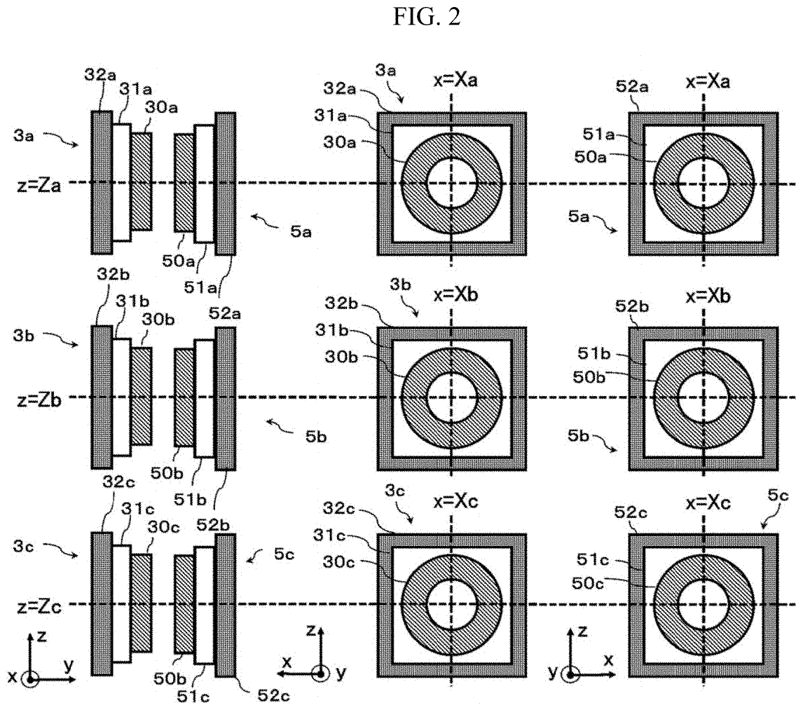

The configuration of a wireless power supply system 100 according to embodiment 1 of the present invention will be described with reference to FIG. 1 and FIG. 2.

The wireless power supply system 100 includes inverters 2a, 2b, 2c for converting power from the main power supply 1 to power having a predetermined frequency, power transmission coil units 3a, 3b, 3c for transmitting power, power reception coil units 5a, 5b, 5c for receiving power, and rectification circuits 6a, 6b, 6c for rectifying the received power. These components, the main power supply 1, and a load 9 are connected via lead wires 10. The inverters 2a, 2b, 2c and the power transmission coil units 3a, 3b, 3c form power transmission devices 4a, 4b, 4c, and the power reception coil units 5a, 5b, 5c and the rectification circuits 6a, 6b, 6c form power reception devices 7a, 7b, 7c. Then, the power transmission devices 4a, 4b, 4c and the power reception devices 7a, 7b, 7c form power transmission/reception devices 8a, 8b, 8c.

Further, the wireless power supply system 100 includes a control unit 11 for selecting the power transmission/reception device 8a, 8b, 8c to be operated, in accordance with a power requirement from the load 9, and communication units 12, 13 for transmitting signals for operating the power transmission/reception device 8a, 8b, 8c selected by the control unit 11, and these units are connected via cables 14.

Hereinafter, the components of the wireless power supply system 100 will be described.

The inverter 2a is connected to output terminals of the main power supply 1 via the lead wires 10, and is a circuit (represented as INV in FIG. 1) for converting DC power supplied from the main power supply 1 via the lead wires 10, to AC power having a predetermined frequency. The predetermined frequency is a frequency close to the resonance frequency of the power transmission/reception device 8a. The inverter 2a is formed by a half-bridge circuit or a full-bridge circuit. Output terminals of the inverter 2a are connected to the lead wires 10 connected to input terminals of the power transmission coil unit 3a.

The inverters 2b, 2c have the same configuration as the inverter 2a.

Here, the main power supply 1 connected to the inverter 2a is a DC power supply for supplying power to be transmitted to the load 9.

Next, the power transmission coil units 3a, 3b, 3c connected to the inverters 2a, 2b, 2c, and the power reception coil units 5a, 5b, 5c provided at positions opposed to the power transmission coil units 3a, 3b, 3c, will be described with reference to FIG. 2.

As shown in FIG. 2, the power transmission coil unit 3a is composed of a power transmission coil 30a, a magnetic body 31a, and a magnetic-shielding plate 32a, and is further provided with a resonant capacitor (not shown) for resonating power that is supplied to the power transmission coil unit 3a. In FIG. 2, a view at the upper left is a side view of the power transmission coil unit 3a, and a view at the upper center is a front view.

The power transmission coil 30a is formed by winding a copper wire with a plurality of turns about the center axis in the y-axis direction in the drawing, and generates a magnetic field around the power transmission coil 30a by AC power supplied from the inverter 2a via the lead wires 10.

The magnetic body 31a is a plate-shaped member made of ferrite or the like, and is placed on a surface of the power transmission coil 30a on the side opposite to a surface thereof opposed to the power reception coil unit 5a. The magnetic body 31a increases the inductance of the power transmission coil 30a, thus reducing the coil size, and reduces a leakage magnetic field generated from the power transmission coil 30a.

The magnetic-shielding plate 32a is a plate-shaped member made of nonmagnetic metal such as aluminum, and is placed on a surface of the magnetic body 31a on the side opposite to a surface thereof opposed to the power transmission coil 30a. The magnetic-shielding plate 32a blocks a leakage magnetic field generated from the power transmission coil 30a, to inhibit erroneous operations of a device located around the wireless power supply system 100 and the like, and heating of metal present therearound.

The resonant capacitor is provided between the inverter 2a and the power transmission coil 30a, and has a predetermined capacitance for adjusting the resonance frequency of the power transmission device 4a.

The power transmission coil units 3b, 3c have the same configuration as the power transmission coil unit 3a. In FIG. 2, the power transmission coil unit 3b (a power transmission coil 30b, a magnetic body 31b, and a magnetic-shielding plate 32b) is shown in views at the left and the center in the middle stage, and the power transmission coil unit 3c (a power transmission coil 30c, a magnetic body 31c, and a magnetic-shielding plate 32c) is shown in views at the left and the center in the lower stage.

As shown in FIG. 2, the power reception coil unit 5a is composed of a power reception coil 50a, a magnetic body 51a, and a magnetic-shielding plate 52a, and further includes a resonant capacitor (not shown) for resonating power that is supplied to the power reception coil unit 5a. In FIG. 2, views at the left and the right in the upper stage are a side view and a front view of the power reception coil unit 5a. The above configuration is generally the same as that of the power transmission coil unit 3a, and a difference will be described below.

Output terminals of the power reception coil unit 5a are connected to the lead wires 10 connected to input terminals of the rectification circuit 6a, and the power reception coil unit 5a receives power transmitted from the power transmission coil unit 3a by the power reception coil 50a and supplies the power to the rectification circuit 6a.

The power reception coil units 5b, 5c have the same configuration as the power reception coil unit 5a. In FIG. 2, the power reception coil unit 5b (a power reception coil 50b, a magnetic body 51b, and a magnetic-shielding plate 52b) is shown in views at the left and the right in the middle stage, and the power reception coil unit 5c (a power reception coil 50c, a magnetic body 51c, and a magnetic-shielding plate 52c) are shown in views at the left and the right in the lower stage.

Here, with reference to FIG. 2, the positional relationship between the power transmission coil units 3a, 3b, 3c and the power reception coil units 5a, 5b, 5c will be described.

As shown in the views at the left in FIG. 2, the power transmission coil units 3a, 3b, 3c and the power reception coil units 5a, 5b, 5c are arranged so as to be aligned in the z-axis direction. The power transmission coil units 3a, 3b, 3c and the power reception coil units 5a, 5b, 5c are respectively arranged with their coil centers located coaxially with each other, and the power transmission coils 30a, 30b, 30c and the power reception coils 50a, 50b, 50c respectively face each other. For example, the center axes of the power transmission coil unit 3a and the power reception coil unit 5a are located at a position of x=Xa and z=Za. The magnetic-shielding plate 32a, the magnetic body 31a, and the power transmission coil 30a are arranged from the left side, and with a certain interval therefrom, the power reception coil 50a, the magnetic body 51a, and the magnetic-shielding plate 52a are arranged. The interval between the coils is set to such a distance that allows power transmission.

At least either the power transmission coil units 3a, 3b, 3c or the power reception coil units 5a, 5b, 5c may be movable, as long as they are arranged at such positions that the coils face each other as shown in FIG. 2 when power transmission is performed.

As shown in FIG. 1, the lead wires 10 connected to output terminals of the power reception coil unit 5a are connected to input terminals of the rectification circuit 6a (represented as D in FIG. 1). Specifically, the rectification circuit 6a is a diode-bridge rectifier, and output terminals thereof are connected to the lead wires 10 connected to input terminals of the load 9. The rectification circuit 6a converts AC power supplied from the power reception coil unit 5a, to DC power, and supplies the DC power to the load 9.

The rectification circuits 6b, 6c have the same configuration as the rectification circuit 6a.

Here, the load 9 differs depending on a target to which the wireless power supply system is provided. For example, in a case of an elevator, the load 9 is an air conditioner, a lighting device, and a display panel in a car, a motor for opening/closing a door, a battery for supplying power to them, and the like. In the present embodiment, an ammeter and a voltmeter are provided to the load 9.

The lead wires 10 are copper wires for transmitting power in a wired manner. The lead wires 10 connect circuits such as the coils and the inverters in the power transmission/reception devices 8a, 8b, 8c, and connect the power transmission/reception devices 8a, 8b, 8c in parallel between the main power supply 1 and the load 9.

The power transmission/reception devices 8a, 8b, 8c connected in parallel have different rated powers, and are each designed so that power transmission efficiency is maximized at power close to the rated power. That is, the power transmission/reception devices 8a, 8b, 8c include three types of power transmission/reception devices different in power at which power transmission efficiency is maximized. Here, the power transmission efficiency is the ratio between power supplied from the main power supply 1 and power received by the load 9. The higher the power transmission efficiency is, the more efficiently the power supplied from the main power supply 1 is received by the load 9.

The sum of the powers (rated powers) at which power transmission efficiencies are maximized in the power transmission/reception devices 8a, 8b, 8c is set to be substantially equal to the maximum power requirement of the load 9, and further, one of the power transmission/reception devices 8a, 8b, 8c is designed such that the power at which power transmission efficiency is maximized is substantially equal to the average power requirement of the load 9. As a specific example, in a case where the maximum power requirement of the load 9 is 6 kW and the average power requirement thereof is 3 kW, the rated power of the power transmission/reception device 8a is set to 3 kW, the rated power of the power transmission/reception device 8b is set to 2 kW, and the rated power of the power transmission/reception device 8c is set to 1 kW. It is noted that the maximum power requirement is the sum of an upper limit value of power consumption set for the air conditioner and the like included in the load 9 and an upper limit value of power (hereinafter, referred to as charge power) needed for charging the battery included in the load 9, and these upper limit values are values set when the load 9 is designed or manufactured. The average power requirement is the sum of an average value of power consumption when the air conditioner and the like included in the load 9 are operated during a certain period, and an average value of charge power needed for charging the battery during the same period, and the value of the average power requirement is estimated from the same type of load 9 already provided.

The reason why the power transmission/reception devices 8a, 8b, 8c are designed as described above is as follows.

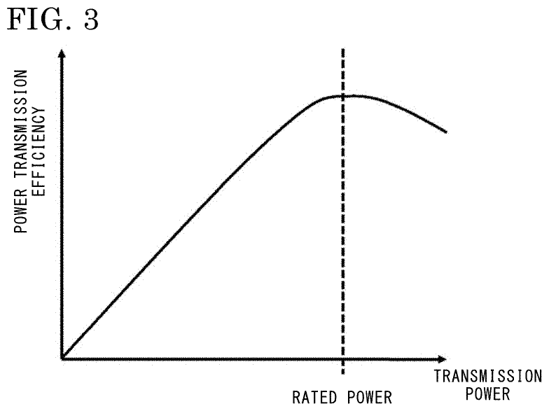

In a general wireless power supply system, if designing is made such that the maximum power transmission efficiency is obtained at the rated power, as shown in FIG. 3, operation with the maximum efficiency cannot be performed at transmission power other than the rated power, and in particular, when transmission power is small, power transmission efficiency is deteriorated. In the wireless power supply system 100 according to embodiment 1 of the present invention, the sum of the rated powers of the power transmission/reception devices 8a, 8b, 8c is set to be substantially equal to the maximum power requirement so that power can be transmitted with high power transmission efficiency when the air conditioner and the like of the load 9 are operated at the maximum outputs and the remaining battery amount is small, i.e., when power corresponding to the maximum power requirement is needed. In addition, the rated power of one of the power transmission/reception devices 8a, 8b, 8c is set to be substantially equal to the average power requirement so that power can be transmitted with high power transmission efficiency when the load 9 is operated at an average output and the remaining battery amount is an average amount, i.e., when power corresponding to the average power requirement is needed. In addition, the rated powers of the power transmission/reception devices 8a, 8b, 8c are set to be different from each other so that power can be transmitted with high power transmission efficiency for a plurality of power requirements.

Information about the rated powers of the power transmission/reception devices 8a, 8b, 8c is stored in a memory 111 or a storage device 112 of the control unit 11 described later when the wireless power supply system 100 is manufactured or installed, and is used when the control unit 11 selects the power transmission/reception device to be operated.

Next, with reference to FIG. 1 again, the control unit 11 and the communication units 12, 13 included in the wireless power supply system 100 will be described.

The control unit 11 has a function of calculating power consumption and necessary charge power for the load 9 and determining the power requirement. In addition, the control unit 11 has a function of selecting one or a combination of the power transmission/reception devices 8a, 8b, 8c to be operated, on the basis of the determined power requirement.

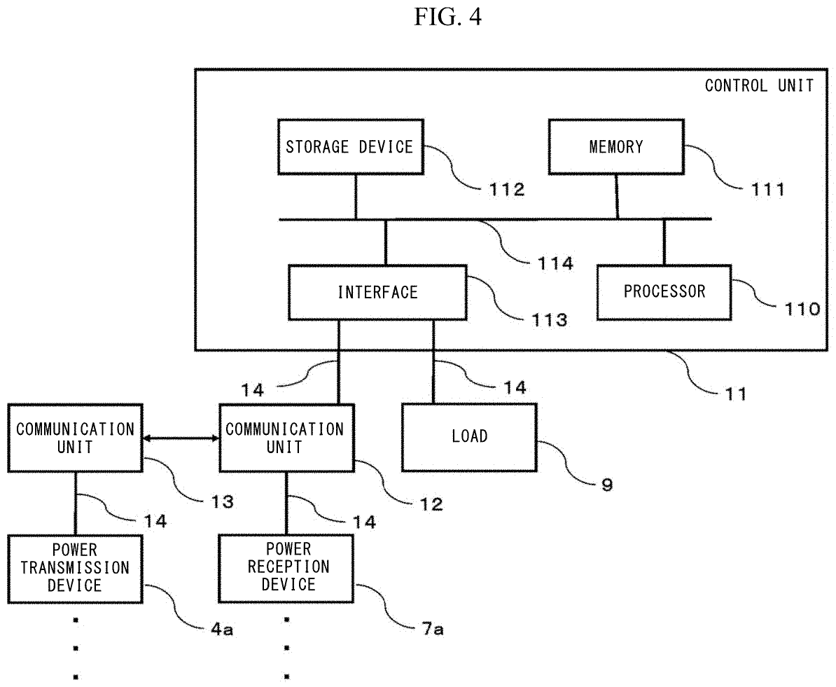

The detailed configuration of the control unit 11 is shown in FIG. 4. The control unit 11 is a microcomputer and includes a processor 110, the memory 111, the storage device 112, an interface 113, and a data bus 114.

The processor 110 loads various programs such as a program for determining the power requirement of the load 9 and a program for selecting the power transmission/reception device 8a, 8b, 8c to be operated, from the storage device 112 onto the memory 111, and executes the programs.

The memory 111 is a volatile storage medium such as a random access memory (RAM), and is used as a program loading area, various caches, and buffers when the processor 110 executes the programs.

The storage device 112 is a nonvolatile storage medium having a large capacity, such as a hard disk drive (HDD) or a solid state disk (SSD), and stores various programs to be executed by the processor 110, and the like.

The interface 113 receives signals indicating a current value and a voltage value from an ammeter, a voltmeter, and the like provided to the load 9. In addition, the interface 113 transmits, to the selected power transmission/reception device 8a, 8b, 8c, a signal for operating the power transmission/reception device.

The data bus 114 is a transmission path communicably connecting the processor 110, the memory 111, the storage device 112, and the interface 113.

As shown in FIG. 1 and FIG. 4, the communication units 12, 13 are communication devices that communicate with each other using wireless communication such as Wi-Fi (Wireless Fidelity, registered trademark) or Bluetooth (registered trademark). The communication unit 12 is connected to the control unit 11 and the power reception devices 7a, 7b, 7c via the cables 14, and the communication unit 13 is connected to the power transmission devices 4a, 4b, 4c via the cable 14.

When the communication unit 12 has received a signal for operating the power transmission/reception device from the control unit 11, the communication unit 12 transmits a signal for operating the power transmission/reception device to the power reception device 7a, 7b, 7c, thus operating the corresponding power reception device.

In addition, when the communication unit 12 has received the signal for operating the power transmission/reception device, the communication unit 12 transmits this signal to the communication unit 13 via wireless communication, and the communication unit 13 transmits a signal for operating the power transmission/reception device to the power transmission device 4a, 4b, 4c, thus operating the corresponding power transmission device.

The cables 14 connecting the communication unit 12 and the control unit 11, the communication unit 12 and the power reception devices 7a, 7b, 7c, and the communication unit 13 and the power transmission devices 4a, 4b, 4c, are wire cables through which a signal outputted from the control unit 11 is transmitted (FIG. 1 and FIG. 4).

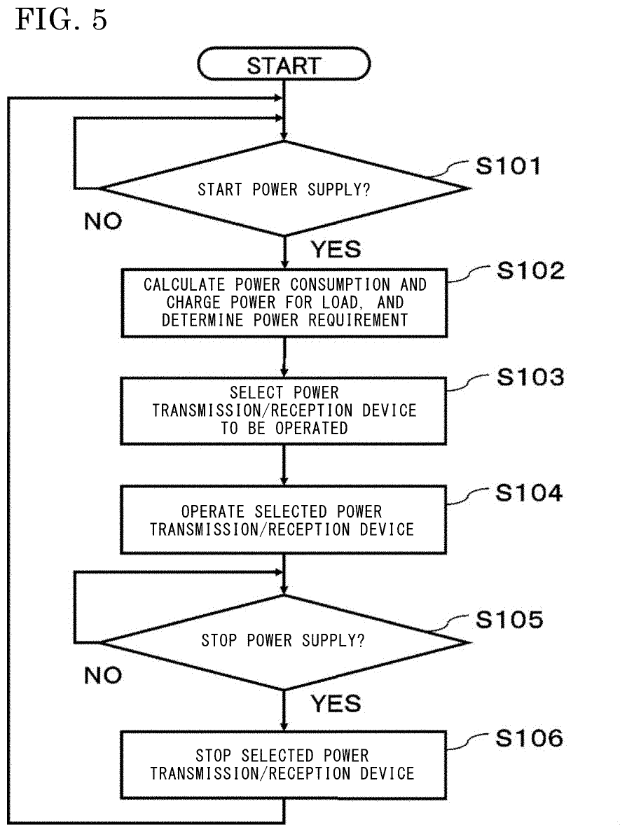

Thus, the configuration of the wireless power supply system 100 has been described. Next, with reference to FIG. 5, operation of the wireless power supply system 100 will be described.

A process in the flowchart shown in FIG. 5 is started at the same time as the wireless power supply system 100 is operated.

The control unit 11 determines whether or not to start supply of power on the basis of a power supply requirement from an apparatus (e.g., elevator) to which the wireless power supply system 100 is provided (step S101).

Specifically, in a case of an elevator, when the processor 110 has received a signal indicating that the elevator is stopped at a stop position where power is to be supplied (this signal corresponds to a power supply requirement because power is supplied at the time of the stoppage) from a main control device for the elevator provided at the uppermost part of the hoistway, the processor 110 determines to start supply of power. When the signal is not received, the processor 110 determines not to start supply of power.

If the control unit 11 (processor 110) determines not to start supply of power (NO in step S101), the control unit 11 repeats determination as to whether or not a power supply requirement is received (step S101).

If the control unit 11 determines to start supply of power (YES in step S101), the control unit 11 calculates power consumption and necessary charge power for the load 9 on the basis of the current value and the voltage value acquired from the ammeter and the voltmeter provided to the load 9, and determines a power requirement on the basis of the above calculated values (step S102).

Specifically, the ammeter and the voltmeter of the load 9 transmit a current value and a voltage value as appropriate to the control unit 11, and the current value and the voltage value are sequentially stored into the memory 111 or the storage device 112 (hereinafter, referred to as memory 111 or the like). The processor 110 reads the current value and the voltage value whose times are closest to the present time, from the memory 111 or the like, and integrates these values to calculate power consumption of the load 9. In addition, the processor 110 reads open-circuit voltage of the battery before supply of power is started, from the memory 111 or the like, and compares the open-circuit voltage with the state-of-charge (SOC) characteristics of the battery separately stored in the memory 111 or the like, to approximately calculate a discharge amount. Alternatively, the discharge amount may be calculated by integrating discharge current of the battery. The discharge amount or a part of this is necessary charge power. The power consumption and the necessary charge power approximately correspond to power needed by the load 9 at present. Therefore, the sum of the power consumption and the necessary charge power is calculated as a power requirement of the load 9. The power requirement may be calculated by, for example, multiplying the sum of the power consumption and the necessary charge power by a predetermined coefficient in consideration of loss when power is supplied to the load 9, and the like.

The control unit 11 selects the power transmission/reception device 8a, 8b, 8c of which the rated power is not less than the power requirement of the load 9 or a combination of at least two power transmission/reception devices 8a, 8b, 8c of which the sum of the rated powers is not less than the power requirement of the load 9 (step S103).

Specifically, the processor 110 reads the rated powers of the power transmission/reception devices 8a, 8b, 8c from the memory 111 or the like, and subtracts each rated power from the power requirement of the load 9, to calculate a difference value (if the difference value is positive, the power requirement is greater than the rated power). Then, the processor 110 selects the power transmission/reception device for which the difference value is closest to zero, among the power transmission/reception devices for which the difference values are zero or negative. In the case where the difference value is zero or negative, the rated power of the selected power transmission/reception device is greater than the power requirement, and the power requirement of the load 9 can be covered by only the power transmission/reception device. Thus, the selection processing is finished (step S103).

On the other hand, in a case where there are no power transmission/reception devices for which the difference values are zero or negative, and there are only power transmission/reception devices for which the difference values are positive, the processor 110 selects the power transmission/reception device for which the difference value is closest to zero. However, power that can be supplied by only the selected power transmission/reception device is insufficient. Therefore, the processor 110 subtracts the rated power of each of the other power transmission/reception devices from the above difference value, to calculate a second difference value. Then, if there are power transmission/reception devices for which the second difference values are zero or negative, the processor 110 selects the power transmission/reception device for which the second difference value is closest to zero, among the power transmission/reception devices for which the second difference values are zero or negative, and finishes the selection processing (step S103). This is because, when the second difference value is zero or negative, the power requirement of the load 9 can be covered by the selected two power transmission/reception devices.

Further, in a case where there are only power transmission/reception devices for which the second difference values are positive, the remaining power transmission/reception device is selected. It is noted that, since there is one power transmission/reception device remaining, the selection is performed without using a difference value. However, as in the cases of selecting the first and second power transmission/reception devices, the selection may be performed by calculating a third difference value. In addition, in a case where the wireless power supply system 100 has four or more power transmission/reception devices, the same processing is repeated until the power requirement can be covered by the selected power transmission/reception devices. That is, in the above selection processing, the power transmission/reception devices are selected one by one, and when it has become possible to cover the power requirement of the load 9, the rest of the power transmission/reception devices are no longer selected. Therefore, the control unit 11 selects only the power transmission/reception device(s) for which the rated power or the sum of the rated powers is not less than the power requirement of the load 9, from among the power transmission/reception devices 8a, 8b, 8c.

Here, using the aforementioned specific example, selection of the power transmission/reception devices by the control unit 11 will be described. The aforementioned example is the case where the maximum power requirement of the load 9 is 6 kW and the average power requirement thereof is 3 kW, and then the rated power of the power transmission/reception device 8a is 3 kW, the rated power of the power transmission/reception device 8b is 2 kW, and the rated power of the power transmission/reception device 8c is 1 kW.

In a case where the power requirement of the load 9 is 3 kW which is the average power requirement, the control unit 11 compares 3 kW with the rated power of each power transmission/reception device 8a, 8b, 8c. Only the power transmission/reception device 8a is the one for which the difference value is zero or negative. Therefore, the power transmission/reception device 8a is selected as the power transmission/reception device having the closest rated power. In addition, the difference value is zero at this stage, and therefore selection of the power transmission/reception devices is not performed any longer. In this case, for supplying power of 3 kW to the load 9, the power transmission/reception device 8a is to transmit power of 3 kW which is equal to the rated power, and thus power can be transmitted with high power transmission efficiency.

In a case where the power requirement of the load 9 is 6 kW which is the maximum power requirement, the control unit 11 compares 6 kW with the rated power of each power transmission/reception device 8a, 8b, 8c. The difference value is 3 for the power transmission/reception device 8a, 4 for the power transmission/reception device 8b, and 5 for the power transmission/reception device 8c, i.e., all the difference values are positive. Since the difference value for the power transmission/reception device 8a is closest to zero, the power transmission/reception device 8a is selected. Subsequently, the control unit 11 compares 3 which is the difference value with the rated power for each power transmission/reception device 8b, 8c. The second difference value is 1 for the power transmission/reception device 8b, and 2 for the power transmission/reception device 8c, i.e., all the second difference values are positive. Since the difference value for the power transmission/reception device 8b is closest to zero, the power transmission/reception device 8b is selected. Further, since the second difference values are all positive, the control unit 11 selects the power transmission/reception device 8c. Eventually, the control unit 11 selects all the power transmission/reception devices 8a, 8b, 8c. In this case, for supplying 6 kW to the load 9, the power transmission/reception devices 8a, 8b, 8c are to respectively transmit powers of 3 kW, 2 kW, and 1 kW which are equal to their rated powers. Thus, power can be transmitted with high power transmission efficiency.

In a case where the power requirement of the load 9 is 1 kW, the same processing as described above is performed and the power transmission/reception device 8c is selected. In a case where the power requirement of the load 9 is 2 kW, the power transmission/reception device 8b is selected. In a case where the power requirement of the load 9 is 4 kW, the power transmission/reception devices 8a and 8c are selected. In a case where the power requirement of the load 9 is 5 kW, the power transmission/reception devices 8a and 8b are selected.

In a case where the difference value, the second difference value, or the like is not zero, e.g., in a case where the power requirement is 3.5 kW, first, the power transmission/reception device 8a for which the difference value is smallest is selected, and next, the power transmission/reception device 8c for which the second difference value is negative and has the smallest magnitude is selected. In this case, powers of the power transmission/reception devices 8a and 8c are adjusted so that power of 3.5 kW is outputted. However, since the power transmission/reception devices for which the difference values are small are selected, the adjustment width is small and therefore deterioration in power transmission efficiency is small.

Next, the control unit 11 generates a signal indicating the selected power transmission/reception device, and transmits the signal to the power transmission device 4a, 4b, 4c and the power reception device 7a, 7b, 7c via the communication units 12, 13, to operate the selected power transmission/reception device (step S104). In the operation, the power transmission/reception devices that are not selected are not operated.

Specifically, the processor 110 generates a signal for operating the selected power transmission/reception device among predetermined signals for operating the power transmission/reception devices 8a, 8b, 8c, and transmits the generated signal to the communication unit 12 via the interface 113. When the communication unit 12 has received the signal, the communication unit 12 transmits the signal to the power reception device 7a, 7b, 7c via the cable 14 and transmits the signal to the communication unit 13 via wireless communication. When the communication unit 13 has received the signal, the communication unit 13 transmits the signal to the power transmission device 4a, 4b, 4c via the cable 14. The power transmission device 4a, 4b, 4 and the power reception device 7a, 7b, 7c operate to transmit power if the received signal is the signal for operating the own corresponding power transmission/reception device.

In a case where it is necessary to perform power adjustment as described above, the control unit 11 transmits a signal for performing power adjustment to any of the power transmission/reception devices, together with the signal for operating the selected power transmission/reception device described above. The signal for performing power adjustment is a signal for changing a drive frequency of the inverter 2a, 2b, 2c or a signal for performing phase-shift control thereof.

Next, the control unit 11 determines whether or not to stop supply of power on the basis of a power supply stop requirement from the apparatus (e.g., elevator) to which the wireless power supply system 100 is provided (step S105).

Specifically, in a case of an elevator, the processor 110 receives a signal indicating that the elevator is to be moved from the stop position where power is supplied (this signal corresponds to a power supply stop requirement because power is not supplied during the movement) from the main control device for the elevator provided at the uppermost part of the hoistway, and determines to stop supply of power. When the signal is not received, the processor 110 determines not to stop supply of power.

If the control unit 11 determines not to stop supply of power (NO in step S105), the control unit 11 repeats determination as to whether or not a power supply stop requirement is received (step S105).

If the control unit 11 determines to stop supply of power (YES in step S105), the control unit 11 generates a signal indicating that supply of power is to be stopped, and transmits the signal to the power transmission device 4a, 4b, 4c and the power reception device 7a, 7b, 7c via the communication units 12, 13, to stop the power transmission/reception device 8a, 8b, 8c (step S106).

Specifically, the processor 110 generates a predetermined signal indicating that supply of power is to be stopped, and transmits the signal to the communication unit 12 via the interface 113. When the communication unit 12 has received the signal, the communication unit 12 transmits the signal to the power reception device 7a, 7b, 7c via the cable 14, and transmits the signal to the communication unit 13 via wireless communication. When the communication unit 13 has received the signal, the communication unit 13 transmits the signal to the power transmission device 4a, 4b, 4c via the cable 14. When having received the signal, the power transmission device 4a, 4b, 4c and the power reception device 7a, 7b, 7c stop power transmission.

Thereafter, the control unit 11 performs the determination processing in step S101 again, to repeat the process in this flowchart.

The wireless power supply system 100 according to embodiment 1 of the present invention is configured as described above and provides the following effects.

The wireless power supply system 100 includes the power transmission/reception devices 8a, 8b, 8c composed of the inverters 2a, 2b, 2c, the power transmission coil units 3a, 3b, 3c, the power reception coil units 5a, 5b, 5c, and the rectification circuits 6a, 6b, 6c, and the power transmission/reception devices 8a, 8b, 8c are connected in parallel between the main power supply 1 and the load 9. That is, the inverters 2a, 2b, 2c are respectively provided to the power transmission/reception devices 8a, 8b, 8c. Therefore, the inverters 2a, 2b, 2c can be designed in accordance with the rated powers of the respective power transmission/reception devices 8a, 8b, 8c. Thus, it is possible to transmit power with high power transmission efficiency even in a case of operating only some of the power transmission/reception devices 8a, 8b, 8c.

The power transmission/reception devices 8a, 8b, 8c composing the wireless power supply system 100 are different in the rated power, i.e., power at which power transmission efficiency is maximized. Therefore, power transmission can be performed with high power transmission efficiency, using seven kinds of powers which are the rated powers of the three power transmission/reception devices 8a, 8b, 8c, the sum of the rated powers of the power transmission/reception devices 8a, 8b, the sum of the rated powers of the power transmission/reception devices 8a, 8c, the sum of the rated powers of the power transmission/reception devices 8b, 8c, and the sum of the rated powers of the power transmission/reception devices 8a, 8b, 8c. Thus, it is possible to perform power transmission with high power transmission efficiency even in a case where the power requirement of the load 9 is variable in a wide range.

The wireless power supply system 100 is designed such that the rated power of one of the power transmission/reception devices 8a, 8b, 8c is equal to the average power requirement of the load 9. Therefore, the average power requirement, which is most likely to arise as the power requirement of the load 9, can be addressed by the rated power of one power transmission/reception device, and thus it is possible to transmit power with high power transmission efficiency in many cases.

In the wireless power supply system 100, if the power requirement of the load 9 is covered by some of the power transmission/reception devices, not all the power transmission/reception devices are selected and operated.

In a case where the power requirement of the load 9 is small and not all the power transmission/reception devices 8a, 8b, 8c need to be operated, if all the power transmission/reception devices are operated, the difference between the power requirement and the sum of the rated powers is great and therefore power needs to be greatly adjusted, so that power transmission efficiency is deteriorated. In the wireless power supply system 100, only the power transmission/reception device having a rated power necessary for covering the power requirement is operated. Therefore, as compared to a case of operating all the power transmission/reception devices to adjust power, the power adjustment width is reduced and thus power transmission efficiency can be improved.

In the wireless power supply system 100, the power requirement is determined on the basis of the sum of power consumption and necessary charge power for the load 9, and thereby the power transmission/reception device 8a, 8b, 8c to transmit power is selected. Thus, it is possible to automatically select the power transmission/reception devices 8a, 8b, 8c without manual operation.

The wireless power supply system 100 can adapt to even a case where the power requirement is high by combining the power transmission/reception devices 8a, 8b, 8c. Therefore, the individual power transmission/reception devices 8a, 8b, 8c can be each formed by a low-output power transmission/reception device, for which components having low withstand property and components for low current can be used, whereby the cost can be reduced. In addition, parts where loss occurs during power transmission can be dispersed. Thus, the cooling structure can be simplified and the cost can be reduced.

### Embodiment 2

Next, embodiment 2 of the present invention will be described. Description of the same configurations and operations as those described in embodiment 1 is omitted, and differences from embodiment 1 will be described below.

In the wireless power supply system 200 of embodiment 2, abnormality in the power transmission/reception devices 208a, 208b, 208c is detected, the power transmission/reception device having abnormality is disconnected from the main power supply 1, the load 9, and the other power transmission/reception devices, and among the other power transmission/reception devices, the power transmission/reception device that can cover the power requirement of the load 9 is selected and operated.

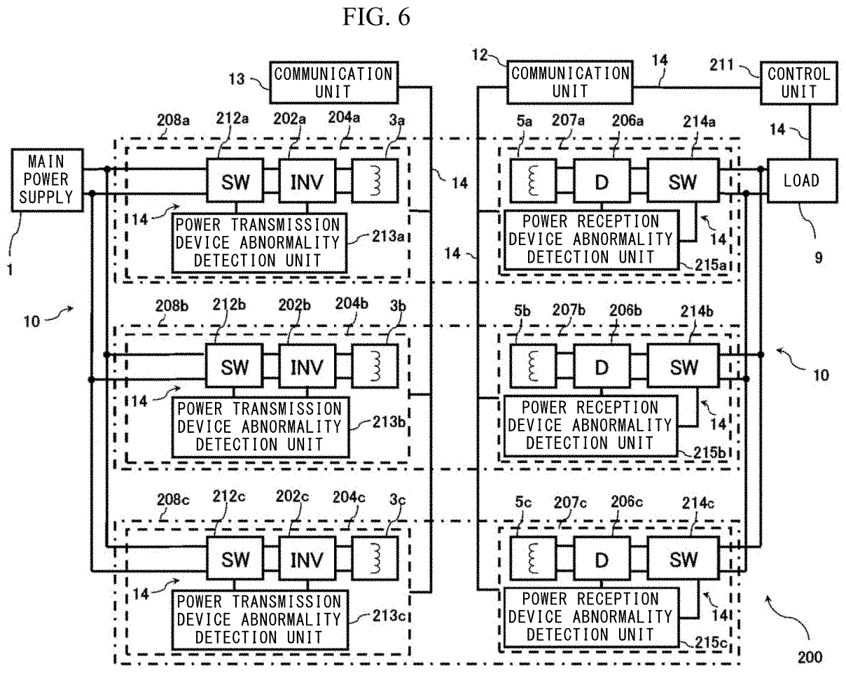

In embodiment 2, inverters 202a, 202b, 202c and rectification circuits 206a, 206b, 206c have ammeters and voltmeters therein. A control unit 211 has a function of selecting the power transmission/reception device to transmit power, from the power transmission/reception devices having no abnormality. Further, as shown in FIG. 6, power transmission devices 204a, 204b, 204c respectively include power transmission switches 212a, 212b, 212c (represented as SW in FIG. 6) provided between the main power supply 1 and the inverters 202a, 202b, 202c, and power transmission device abnormality detection units 213a, 213b, 213c, and power reception devices 207a, 207b, 207c respectively include power reception switches 214a, 214b, 214c (represented as SW in FIG. 6) provided between the rectification circuits 206a, 206b, 206c and the load 9, and power reception device abnormality detection units 215a, 215b, 215c. The other configurations are the same as in embodiment 1 (FIG. 1).

The ammeters provided in the inverters 202a, 202b, 202c and the rectification circuits 206a, 206b, 206c are Hall elements or shunt resistors. The voltmeters are voltage detection transformers or voltage division resistors.

The control unit 211 stores a program for selecting the power transmission/reception device to transmit power, from the power transmission/reception devices having no abnormality, in the memory or the like, and the function of selecting the power transmission/reception device to transmit power, from the power transmission/reception devices having no abnormality, is implemented by the processor executing the program.

The power transmission switch 212a is a semiconductor switch or a mechanical switch, and switches on/off the connection between the main power supply 1 and the inverter 202a. When the power transmission switch 212a is OFF, supply of power from the main power supply 1 to the inverter 202a is interrupted.

The power transmission device abnormality detection unit 213a is connected to the inverter 202a via the cable 14, and has a function of monitoring a current value and a voltage value in the inverter 202a. In addition, the power transmission device abnormality detection unit 213a is connected to the power transmission switch 212a via the cable 14. The power transmission device abnormality detection unit 213a has a function of transmitting a signal for turning off the power transmission switch 212a, to the power transmission switch 212a, when having determined that there is abnormality on the current value or the voltage value in the inverter 202a. When the power transmission switch 212a has received the signal from the power transmission device abnormality detection unit 213a, the power transmission switch 212a switches off the connection.

In addition, the power transmission device abnormality detection unit 213a has a function of transmitting an abnormality detection signal to the power reception device 207a via the communication unit 13 connected to the power transmission device 204a and the communication unit 12 connected to the power reception device 207a. When the power reception switch 214a has received the signal from the power transmission device abnormality detection unit 213a, the power reception switch 214a switches off the connection. The abnormality detection signal includes a signal indicating abnormality and a signal indicating that the power transmission device in which the abnormality is detected is the power transmission device 204a.

It is noted that the power transmission switches 212b, 212c and the power transmission device abnormality detection units 213b, 213c also have the same configurations as the power transmission switch 212a and the power transmission device abnormality detection unit 213a.

The power reception switch 214a is a semiconductor switch or a mechanical switch, and switches on/off the connection between the rectification circuit 206a and the load 9. When the power reception switch 214a is OFF, supply of power from the rectification circuit 206a to the load 9 is interrupted.

The power reception device abnormality detection unit 215a is connected to the rectification circuit 206a via the cable 14, and has a function of monitoring a current value and a voltage value in the rectification circuit 206a. In addition, the power reception device abnormality detection unit 215a is connected to the power reception switch 214a via the cable 14. The power reception device abnormality detection unit 215a has a function of transmitting a signal for turning off the power reception switch 214a, to the power reception switch 214a, when having determined that there is abnormality on the current value or the voltage value in the rectification circuit 206a. When the power reception switch 214a has received the signal from the power reception device abnormality detection unit 215a, the power reception switch 214a switches off the connection.

In addition, the power reception device abnormality detection unit 215a has a function of transmitting an abnormality detection signal to the power transmission device 204a via the communication unit 12 connected to the power reception device 207a and the communication unit 13 connected to the power transmission device 204a. When the power transmission switch 212a has received the signal from the power reception device abnormality detection unit 215a, the power transmission switch 212a switches off the connection.

It is noted that the power reception switches 214b, 214c and the power reception device abnormality detection units 215b, 215c also have the same configurations as the power reception switch 214a and the power reception device abnormality detection unit 215a.

The power transmission device abnormality detection units 213a, 213b, 213c and the power reception device abnormality detection units 215a, 215b, 215c are collectively referred to as abnormality detection units.

Here, the power transmission device abnormality detection units 213a, 213b, 213c and the power reception device abnormality detection units 215a, 215b, 215c are formed by microcomputers, and each include a processor, a memory, a storage device, an interface, and a data bus as in the control unit 11. The storage device stores a program for monitoring a current value and a voltage value, a program for generating a signal for turning off the switch and an abnormality detection signal, thresholds to be compared with the current value and the voltage value, and the like. The processor loads these programs onto the memory and executes them, thus implementing the functions of the power transmission device abnormality detection units 213a, 213b, 213c and the power reception device abnormality detection units 215a, 215b, 215c.

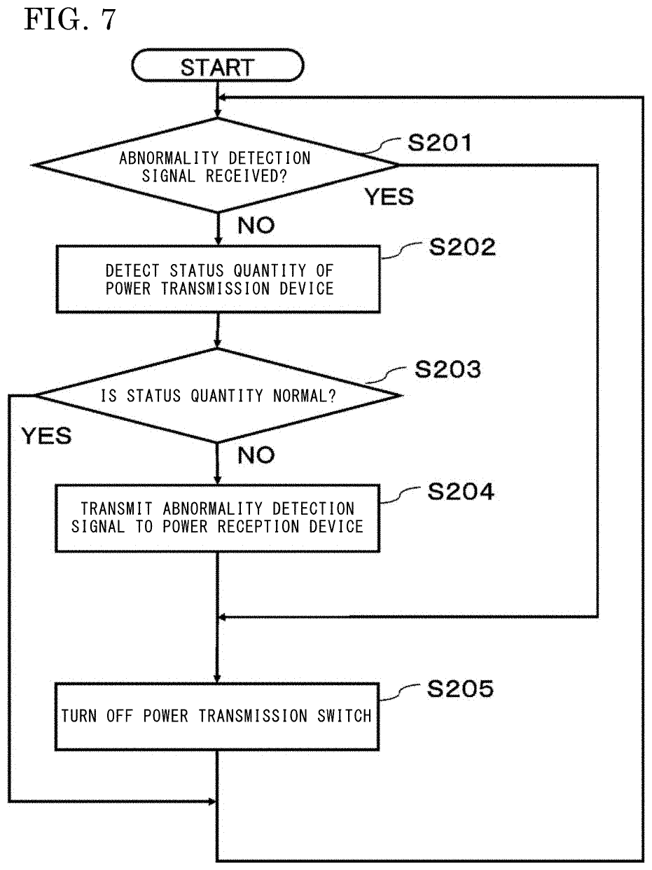

Thus, the configuration of the wireless power supply system 200 has been described. Next, with reference to FIG. 7, operation of the wireless power supply system 200 will be described.

A flowchart in FIG. 7 shows a process by the power transmission device abnormality detection unit 213a in the power transmission device 204a, and this process is started at the same time as the wireless power supply system 200 is operated.

First, the power transmission device abnormality detection unit 213a determines whether or not an abnormality detection signal has been received from the power reception device abnormality detection unit 215a (step S201).

Specifically, when the power reception device abnormality detection unit 215a detects abnormality of the rectification circuit 206a in the power reception device 207a, the power reception device abnormality detection unit 215a transmits an abnormality detection signal to the power transmission device 204a via the communication units 12, 13, and accordingly, the processor of the power transmission device abnormality detection unit 213a determines whether or not the signal has been received.

If the abnormality detection signal has been received (YES in step S201), the power transmission device abnormality detection unit 213a turns off the power transmission switch 212a (step S205).

Specifically, the processor of the power transmission device abnormality detection unit 213a generates a signal for turning off the power transmission switch 212a, and transmits the signal to the power transmission device abnormality detection unit 213a via the cable 14. The power transmission device abnormality detection unit 213a that has received the signal transmits a signal for turning off the power transmission switch 212a to the power transmission switch 212a, whereby the power transmission switch 212a is turned off and the connection between the main power supply 1 and the inverter 202a is interrupted.

On the other hand, if the abnormality detection signal has not been received (NO in step S201), the power transmission device abnormality detection unit 213a performs detection for abnormality of the power transmission device 204a. First, the power transmission device abnormality detection unit 213a detects a current value and a voltage value (collectively represented as status quantity in FIG. 7) of the power transmission device 204a (step S202).

Specifically, the processor of the power transmission device abnormality detection unit 213a acquires a current value and a voltage value outputted from the ammeter and the voltmeter provided to the inverter 202a.

Next, the power transmission device abnormality detection unit 213a determines whether or not the detected current value and voltage value are in a normal range (step S203).

Specifically, the processor of the power transmission device abnormality detection unit 213a compares the current value and the voltage value with thresholds read from the memory. The thresholds represent an upper limit value and a lower limit value of the normal range. If the current value or the voltage value is not between the upper limit value and the lower limit value, this means that there is abnormality in the power transmission device 204a.

If it is determined that the current value or the voltage value is not in a normal range (NO in step S203), the power transmission device abnormality detection unit 213a transmits an abnormality detection signal to the power reception device 207a (step S204). Further, the power transmission device abnormality detection unit 213a turns off the power transmission switch 212a (step S205).

Specifically, the processor of the power transmission device abnormality detection unit 213a generates an abnormality detection signal, and transmits the abnormality detection signal to the power reception device 207a via the communication units 12, 13. On the power reception device 207a side, in response to the abnormality detection signal, the power reception switch 214a is turned off and the connection between the rectification circuit 206a and the load 9 is interrupted. The processing for turning off the power transmission switch 212a is as described above.

On the other hand, if it is determined that the current value and the voltage value are in a normal range (YES in step S203), the power transmission device abnormality detection unit 213a (processor) returns to the processing in step S201 to repeat the process in this flowchart.

The processes by the power transmission device abnormality detection units 213b, 213c are also the same as the process in the flowchart shown in FIG. 7. In addition, the process by the power reception device abnormality detection units 215a, 215b, 215c are similar to the process in the flowchart shown in FIG. 7, but the units that transmit abnormality detection signals in step S201 are the power transmission device abnormality detection units 213a, 213b, 213c. In addition, in step S202, current values and voltage values in the power reception devices 207a, 207b, 207c are detected. In step S204, the transmission destinations of the abnormality detection signals are the power transmission devices 204a, 204b, 204c. The switches to be turned off in step S205 are the power reception switches 214a, 214b, 214c.

The wireless power supply system 200 performs the abnormality detection process shown in FIG. 7, and if there is abnormality in some of the power transmission/reception devices, selects the power transmission/reception device to transmit power, from among the power transmission/reception devices other than the abnormal one. This process will be described below.

If the power transmission device abnormality detection unit 213a, 213b, 213c or the power reception device abnormality detection unit 215a, 215b, 215c detects abnormality in the power transmission/reception device, an abnormality detection signal is transmitted via the communication units 12, 13, and at this time, the abnormality detection signal is also transmitted to the control unit 211. When the control unit 211 has received the abnormality detection signal, the control unit 211 stores information indicating the abnormal transmission/reception device into the memory or the like.

The subsequent processing for selecting the power transmission/reception device to transmit power is the same as that shown in FIG. 5, but in selecting the power transmission/reception device to be operated in step S103, the abnormal power transmission/reception device indicated by the abnormality detection signal is excluded from options.

The wireless power supply system 200 according to embodiment 2 of the present invention is configured as described above, and in addition to the same effects as in embodiment 1, the following effects are provided.

In the wireless power supply system 200, when there is abnormality in either the power transmission device 204a, 204b, 204c or the power reception device 207a, 207b, 207c, both of the power transmission switch 212a, 212b, 212c and the power reception switch 214a, 214b, 214c are turned off. Therefore, if there is abnormality on the power transmission device side, the corresponding power reception device is also disconnected and thus can be inhibited from failing due to power flowing thereto via the lead wire 10 from the other power reception devices that are not disconnected. In addition, when there is abnormality on the power reception device side, the power reception device can be inhibited from failing due to power continuing to be transmitted thereto from the corresponding power transmission device.

In addition, in the wireless power supply system 200, even in a case where some of the power transmission/reception devices have become unable to be used, one or a combination of power transmission/reception devices can be selected from the rest of the power transmission/reception devices and can be operated, whereby it is possible to perform efficient power transmission even when abnormality has occurred.

Here, description of modifications of the wireless power supply system 200 according to embodiment 2 and supplementary description will be given.

The power transmission device abnormality detection units 213a, 213b, 213c detect abnormality in the power transmission devices 204a, 204b, 204c on the basis of current values and voltage values in the inverters 202a, 202b, 202c. However, ammeters and voltmeters may be provided to the power transmission coil units 3a, 3b, 3c, and abnormality may be detected on the basis of current values and voltage values outputted therefrom.

Similarly, also in the power reception device abnormality detection units 215a, 215b, 215c, ammeters and voltmeters may be provided to the power reception coil units 5a, 5b, 5c, and abnormality may be detected on the basis of current values and voltage values outputted therefrom.

The power transmission device abnormality detection units 213a, 213b, 213c and the power reception device abnormality detection units 215a, 215b, 215c are respectively provided in the power transmission devices 204a, 204b, 204c and the power reception devices 207a, 207b, 207c, but may be formed by one microcomputer together with the control unit 211.

### Embodiment 3

Next, embodiment 3 of the present invention will be described. Description of the same configurations and operations as those described in embodiment 1 is omitted, and differences from embodiment 1 will be described below. It is noted that embodiment 3 may be carried out in combination with embodiment 1, embodiment 2, or the modifications thereof.

In embodiment 3, a power reception unit 312 is provided to a car 321 of an elevator 320, and power transmission units 313a, 313d, 313e are provided to a hoistway 322 of the elevator 320. When the car 321 has stopped at a predetermined stop position, the power reception unit 312 and one of the power transmission units 313a, 313d, 313e are opposed to each other, and power is supplied to the car 321.

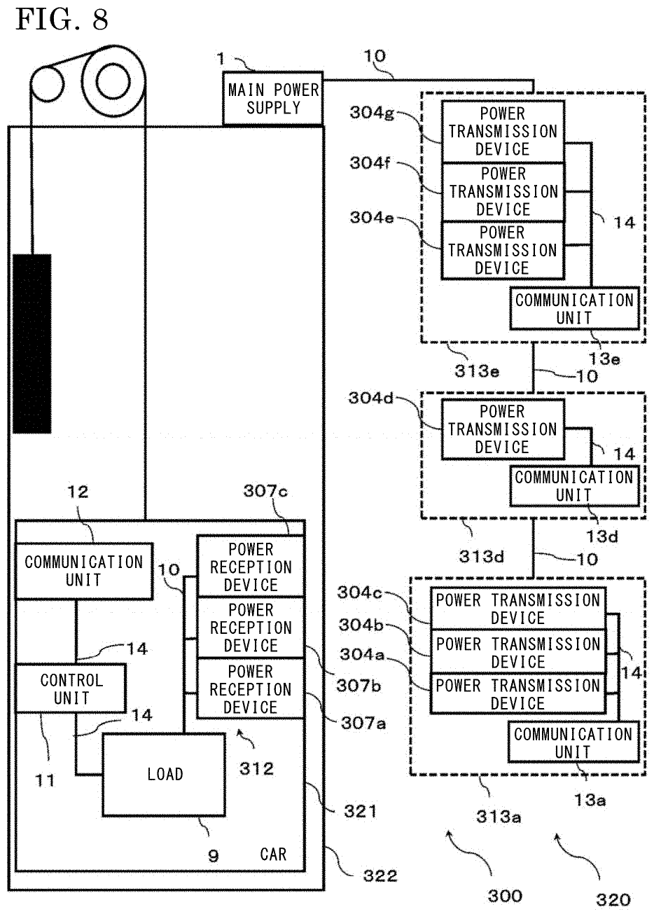

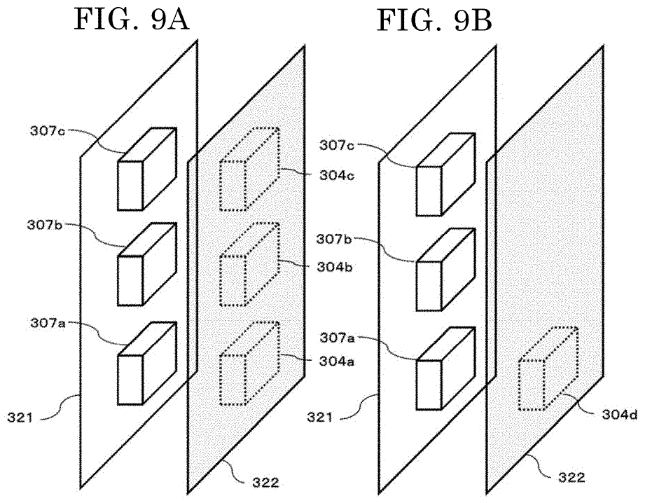

Hereinafter, components of the elevator 320 provided with a wireless power supply system 300 according to embodiment 3 will be described with reference to FIG. 8 and FIG. 9.

As shown in FIG. 8, the elevator 320 is provided inside a building, and is composed of the hoistway 322 extending in the up-down direction and the car 321 that moves up/down in the hoistway 322.

The car 321 is provided with the power reception unit 312, and the power reception unit 312 includes a plurality of power reception devices 307a, 307b, 307c connected to the load 9 via the lead wires 10, the control unit 11 for selecting the power transmission/reception device to be operated, and the communication unit 12 for transmitting a signal for operating the power transmission/reception device.

The configuration of the power reception unit 312 is generally the same as the configuration of the power reception devices 7a, 7b, 7c, the control unit 11, and the communication unit 12 in embodiment 1, and therefore differences will be described below.

The power reception devices 307a, 307b, 307c are provided to a side wall of the car 321 so as to be opposed to a side wall of the hoistway 322.

The elevator 320 includes a plurality of power transmission units 313a, 313d, 313e connected to the main power supply 1. The power transmission unit 313a includes power transmission devices 304a, 304b, 304c and a communication unit 13a, the power transmission unit 313d includes a power transmission device 304d and a communication unit 13d, and the power transmission unit 313e includes power transmission devices 304e, 304f, 304g and a communication unit 13e. The configurations of the power transmission units 313a, 313e are generally the same as the configuration of the power transmission devices 4a, 4b, 4c and the communication unit 12 in embodiment 1, and therefore differences will be described below.

The power transmission units 313a, 313d, 313e are provided to a side wall of the hoistway 322 so that the power reception devices (specifically, power reception coils) of the power reception unit 312 and the power transmission devices (specifically, power reception coils) of one of the power transmission units 313a, 313e are opposed to each other at a stop position of the car 321. Here, the stop position of the car 321 is a position for stepping in/out on each floor of the building. When the car 321 stops at the position where the power reception unit 312 and the power transmission unit 313a are opposed to each other, the power reception devices 307a, 307b, 307c and the power transmission devices 304a, 304b, 304c correspond to the power transmission/reception devices in embodiment 1. When the car 321 stops at the position where the power reception unit 312 and the power transmission unit 313e are opposed to each other, the power reception devices 307a, 307b, 307c and the power transmission devices 304e, 304f, 304g correspond to the power transmission/reception devices in embodiment 1.

The power transmission unit 313d includes only one power transmission device 304d, and the configuration of the power transmission device 304d is the same as the configuration of one of the power transmission devices in embodiment 1. The power (rated power) at which power transmission efficiency is maximized in the power transmission unit 313d is set to be smaller than the sum of powers (rated powers) at which power transmission efficiencies are maximized in the power transmission units 313a, 313e. That is, the output of the power transmission unit 313d is lower than those of the other power transmission units 313a, 313e. When the car 321 stops at the position where the power reception unit 312 and the power transmission unit 313d are opposed to each other, the power transmission device 304d and one of the power reception devices 307a, 307b, 307c are opposed to each other. The combination of the opposed devices corresponds to the power transmission/reception device in embodiment 1.

The reason why the output of the power transmission unit 313d is lower than those of the power transmission units 313a, 313e is as follows. At a stop position of the car 321, the doors are opened so that occupants step in and out. When the doors are opened, air inside the car 321 is replaced with the outside air, and the amount of the air flowing in from the outside increases in proportion to the door opened period. Therefore, at a stop position where the door opened period is long, the air conditioner which is a part of the load 9 needs to be increased in output, so that the power requirement increases. In contrast, at a stop position where the door opened period is short, the output of the air conditioner may be low, so that the power requirement decreases. Therefore, at such a stop position where a fewer number of occupants step in and out on average, i.e., the door opened period is short on average, the power transmission/reception units with a low output are sufficient, and thus the power transmission unit 313d with a low output is provided at the stop position where the door opened period is short.

It is noted that such average door opened periods may be calculated in advance at each floor in buildings located at similar sites and having similar purposes and similar heights.

Here, the power transmission coils included in the power transmission unit 313a or 313e are referred to as first power transmission coils, and the power transmission coil included in the power transmission unit 313d is referred to as a second power transmission coil. The power at which power transmission efficiency is maximized in the power transmission/reception device composed of the power reception unit 312 and the power transmission unit 313d including the second power transmission coil is different from and smaller than the sum of the powers at which power transmission efficiencies are maximized in the power transmission/reception devices composed of the power reception unit 312 and the power transmission unit 313a including the first power transmission coils.

FIG. 9(a) shows a state in which the car 321 stops at a stop position where the door opened period is long, specifically, a principal floor such as the first floor, and the power transmission unit 313a and the power reception unit 312 are opposed to each other. As shown in FIG. 9(a), the power transmission devices 304a, 304b, 304c are arranged at certain intervals in the movement direction of the car 321, and the power reception devices 307a, 307b, 307c are also arranged at the same intervals. Therefore, when the car 321 stops, the power transmission devices 304a, 304b, 304c and the power reception devices 307a, 307b, 307c are respectively opposed to each other, so that power transmission can be performed.

FIG. 9(b) shows a state in which the car 321 stops at a stop position where the door opened period is short, specifically, a floor such as the second or third floor where a fewer number of occupants step in and out, and the power transmission unit 313d and the power reception unit 312 are opposed to each other. As shown in FIG. 9(b), the power transmission device 304d composing the power transmission unit 313d is opposed to the lowermost power reception device 307a among the power reception devices composing the power reception unit 312, so that power transmission can be performed. It is noted that, although it is described that the power transmission device 304d is opposed to the lowermost power reception device 307a, the power transmission device 304a may be provided so as to be opposed to the power reception device 307b or 307c.

Operation of the wireless power supply system 300 is the same as in embodiment 1, but the destination to which the communication unit 12 of the power reception unit 312 transmits a signal for operating the power transmission/reception device differs depending on the stop position. In embodiment 3, the communication unit 12 transmits a signal to the communication unit 13 of the power transmission unit closest to the stop position, so that the power transmission unit and the power reception unit opposed to each other at the stop position are operated to transmit power. In a case where the car 321 stops at the stop position opposed to the power transmission unit 313d, since there is only one power transmission device 304d, the control unit 11 operates the power transmission/reception device without performing the selection processing for the power transmission/reception device.

The elevator 320 provided with the wireless power supply system 300 according to embodiment 3 of the present invention is configured as described above, and in addition to the same effects as in embodiment 1, the following effects are provided.

The elevator 320 supplies power to the load 9, using the wireless power supply system 300. Therefore, a power supply cable for connecting the main power supply 1 and the load 9 is not needed. In a case of installing the elevator 320 in a high-rise building, the power supply cable is extremely long, the weight applied to the car 321 increases, and the size of a hoisting device for moving the car 321 increases. However, providing the wireless power supply system 300 as in the elevator 320 according to embodiment 3 can suppress size increase of the hoisting device.

The load 9 of the elevator includes not only the air conditioner in the car but also a plurality of loads 9 such as a lighting device, a display panel, a motor for opening/closing the doors, and a battery for supplying power thereto. The power requirements of these loads 9 greatly vary depending on differences in the door opened period, the number of occupants, outside temperature, and the like. The wireless power supply system 300 can select the power transmission/reception device to transmit power, in accordance with the power requirements. Thus, it is possible to supply power with high power transmission efficiency appropriately in accordance with the usage condition and environment of the elevator 320.

In the elevator 320, the output of the power transmission unit provided at a stop position where the average door opened period is shorter is set to be smaller. At a stop position where the average door opened period is short, a less amount of outside air flows in when the doors of the car 321 are opened, and therefore the output of the air conditioner may be low. Thus, power can be supplied even by the power transmission unit with a low output. Such a power transmission unit with a low output can be provided at low cost and in a limited space. Accordingly, by providing power transmission units with low outputs in accordance with door opened periods, the cost and the space for installing the elevator 320 can be reduced.

Here, description of modifications of the elevator 320 according to embodiment 3 and supplementary description will be given.

As in embodiment 1, the elevator 320 determines the power requirement on the basis of power consumption and necessary charge power for the load 9, and operates the power transmission/reception devices accordingly. However, the control unit 11 may acquire information about the stop position from a main control device (not shown) for the elevator 320, and determine the power requirement on the basis of the information about the stop position. As described above, the stop positions of the elevator 320 include principal floors and the other floors. The door opened period is long at the principal floors, and the door opened period is short at the other floors. Thus, the power requirement is smaller at a floor where the door opened period is shorter. Therefore, the control unit 11 may control the power transmission/reception devices so that power to be transmitted becomes smaller at a floor where the door opened period is shorter. Specifically, a table representing the stop positions and predicted power requirements may be stored in the memory 111 or the like of the control unit 11, and the control unit 11 may determine the power requirement by referring to the table when having acquired information about the stop position. In this way, the power requirement can be determined even when the load 9 provided with no ammeters and no voltmeters is provided to the elevator 320.

In addition, the power requirement may be determined using the door opened period in combination with power consumption and necessary charge power for the load 9. Thus, the power requirement can be determined more accurately.

The elevator 320 includes three power transmission units 313a, 313d, 313e, but this is merely an example and the number of power transmission units is not limited to three. The power transmission units may be provided at the respective stop positions, or may be provided only at some of the stop positions.

The elevator 320 includes one power transmission unit 313d with a low output, but this is merely an example and the number of such power transmission units is not limited to one. The power transmission units 313d with low outputs may be provided at all of a plurality of floors where the door opened period is short.

The power transmission units 313a, 313e each include three power transmission devices, the power transmission unit 313d includes one power transmission device, and the power reception unit 312 includes three power reception devices. However, the numbers of these devices may be changed in consideration of the magnitude of power to be transmitted, the cost, the space, and the like. In a case where a plurality of power transmission devices are provided to the power transmission unit 313d, the power transmission devices shown in embodiment 1, embodiment 2, or the modifications thereof may be used.

It has been assumed that the elevator 320 performs power transmission on stop floors which are stop positions. However, power transmission may be performed at a position other than a stop floor where occupants step in and out, and the power transmission unit may be provided at such a position.

Hereinafter, modifications of the wireless power supply systems 100, 200, 300 or the elevator 320 according to embodiments 1 to 3 will be described.

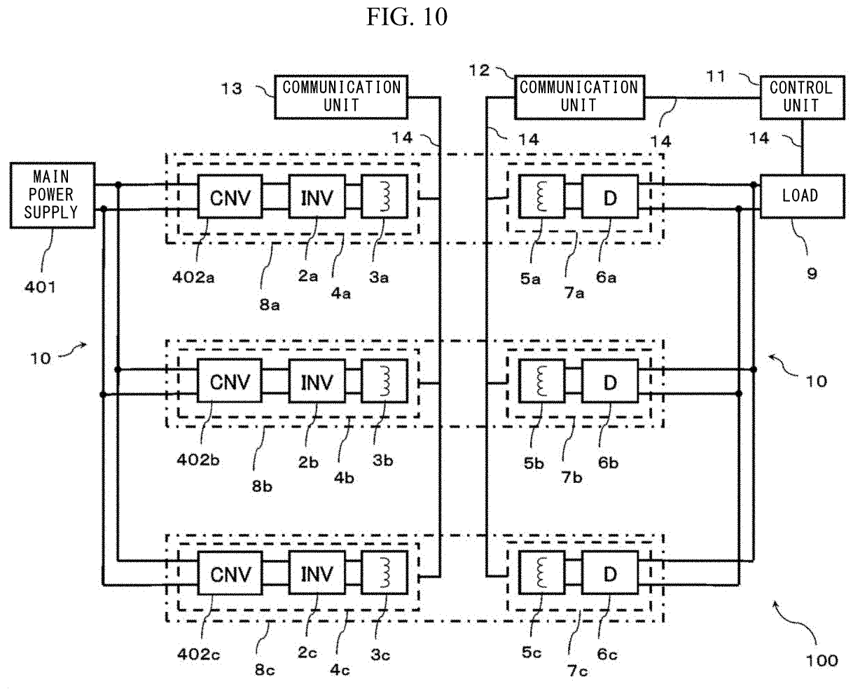

In embodiments 1 to 3, the main power supply 1 is a DC power supply. However, an AC power supply such as a commercial power supply may be used. In this case, as shown in FIG. 10, AC/DC converters 402a, 402b, 402c (represented as CNV in FIG. 10) may be provided between a main power supply 401 which is an AC power supply and the inverters 2a, 2b, 2c. The AC/DC converters 402a, 402b, 402c may be configured so as to correspond to the number of phases of the main power supply 1. In addition, a power factor improvement function may be added to the AC/DC converters 402a, 402b, 402c.

With the above configuration, the same effects as in embodiments 1 to 3 can be obtained even in a case where the main power supply 401 is an AC power supply. In addition, the drive frequencies of the inverters 2a, 2b, 2c need not be changed for adjusting power, thus providing an effect that high-frequency noise can be easily coped with.

In a case of applying the configuration shown in FIG. 10 to embodiment 2, the power transmission switches 212a, 212b, 212c may be provided between the main power supply 401 and the AC/DC converters 402a, 402b, 402c. In addition, ammeters and voltmeters may be provided to the AC/DC converters 402a, 402b, 402c, and may be connected to the power transmission device abnormality detection units 213a, 213b, 213c, so as to perform abnormality detection for the power transmission devices 204a, 204b, 204c.

In the wireless power supply systems 100, 200, 300 according to embodiments 1 to 3, the rectification circuits 6a, 6, b, 6c, 206a, 206b, 206c are individually provided to the power reception devices 7a, 7b, 7c, 207a, 207b, 207c. However, one common rectification circuit may be provided between the power reception devices 7a, 7b, 7c, 207a, 207b, 207c and the load 9. In addition, the rectification circuits 6a, 6b, 6c, 206a, 206b, 206c may be, instead of diode bridge rectifiers, AC/DC converters having voltage conversion functions.

The wireless power supply systems 100, 200 according to embodiments 1 and 2 include three power transmission/reception devices 8a, 8b, 8c, 208a, 208b, 208c.

However, the number of power transmission/reception devices is not limited to three.

The wireless power supply systems 100, 200, 300 according to embodiments 1 to 3 are designed so that the sum of the rated powers of the power transmission/reception devices 8a, 8b, 8c, 208a, 208b, 208c is equal to the maximum power requirement of the load 9. However, the wireless power supply systems 100, 200, 300 may be designed so that the rated power of one of the power transmission/reception devices 8a, 8b, 8c, 208a, 208b, 208c included in the wireless power supply systems 100, 200, 300 is equal to the maximum power requirement of the load 9 or the sum of the rated powers of several power transmission/reception devices 8a, 8b, 8c, 208a, 208b, 208c becomes the maximum power requirement of the load 9.

The wireless power supply systems 100, 200, 300 according to embodiments 1 to 3 are designed so that the rated power of one of the power transmission/reception devices 8a, 8b, 8c, 208a, 208b, 208c is equal to the average power requirement of the load 9. However, the wireless power supply systems 100, 200, 300 may be designed so that the sum of the rated powers of at least two of the power transmission/reception devices 8a, 8b, 8c, 208a, 208b, 208c is equal to the average power requirement of the load 9.

The wireless power supply systems 100, 200, 300 according to embodiments 1 to 3 are designed so that the rated powers of the power transmission/reception devices 8a, 8b, 8c, 208a, 208b, 208c are different from each other. However, some or all of the power transmission/reception devices 8a, 8b, 8c, 208a, 208b, 208c may have the same rated power. That is, the power transmission/reception devices 8a, 8b, 8c, 208a, 208b, 208c may be constituted of one type or may be constituted of at least two types. In this way, the wireless power supply systems 100, 200, 300 can be configured by designing, manufacturing, and combining the power transmission/reception devices having the same rated power. Thus, the designing and manufacturing cost can be reduced.

In the wireless power supply systems 100, 200, 300 according to embodiments 1 to 3, coils of copper wires are used. However, in order to reduce increase in the resistance due to the skin effect, a so-called litz wire formed by twisting together a plurality of thin copper wires coated with an insulating coat may be used.

While the power transmission coil units 3a, 3b, 3c and the power reception coil units 5a, 5b, 5c have the same configuration, the sizes of the coils, the magnetic bodies, and the magnetic-shielding plates may be different.

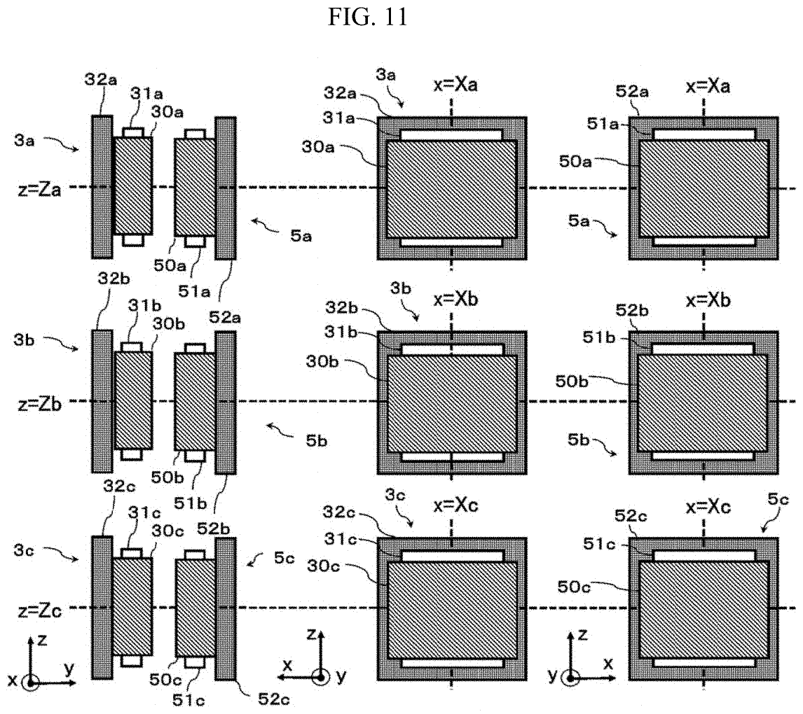

The coils included in the power transmission coil units 3a, 3b, 3c and the power reception coil units 5a, 5b, 5c are formed by winding a copper wire with a plurality of turns about the y-axis direction in FIG. 2. However, as shown in FIG. 11, a copper wire or a litz wire may be wound around the outer circumference of each of the magnetic bodies 31a, 31b, 31c and the magnetic bodies 51a, 51b, 51c, to form a solenoid coil.

In the wireless power supply systems 100, 200, 300 according to embodiments 1 to 3, the power transmission coil units 3a, 3b, 3c are provided with resonant capacitors. This is for transmitting power by a magnetic resonance method. In a case of transmitting power by an electromagnetic induction method, resonant capacitors are not needed.

In the wireless power supply systems 100 and 200 according to embodiments 1 and 2, the control units 11, 211 determine the power requirement on the basis of power consumption and necessary charge power for the load 9, and select the power transmission/reception device to transmit power. However, in a case where power consumption of an apparatus to which the wireless power supply system 100, 200, 300 is provided and necessary charge power for charging the battery thereof can be estimated in advance in accordance with the conditions, the estimated values may be stored as power requirements in the memory or the like of the control unit 11, 211, and when each condition arises, the power transmission/reception device to transmit power may be selected accordingly. Specifically, as shown in embodiment 3, stop positions and power requirements may be stored in association with each other. In this case, the load 9 need not be provided with an ammeter and a voltmeter, and the control unit 11, 211 need not calculate power consumption and necessary charge power.

In a case where the load 9 does not include a battery, the power requirement may be determined on the basis of only power consumption of apparatuses such as an air conditioner included in the load 9. In a case where apparatuses such as an air conditioner included in the load 9 are operated with only a battery, the power requirement may be determined on the basis of only necessary charge power for the battery.

In a case where the load 9 has a function of determining the power requirement, the control unit 11, 211 may receive the power requirement from the load 9.

The control unit 11, 211 selects the power transmission/reception devices by comparing them with the power requirement one by one. However, the rated powers of the power transmission/reception devices 8a, 8b, 8c, 208a, 208b, 208c and the sums of the rated powers of combinations thereof may be stored in the memory or the like of the control unit 11, 211, and the power requirement may be compared with the rated powers and the sums of the rated powers that are stored, to select one or a combination of the power transmission/reception devices for which the difference value is negative and closest to zero.

The communication units 12, 13 perform wireless communication such as Wi-Fi. However, the communication units 12, 13 may perform wired communication using a communication cable with measures taken against disturbance.

The control units 11, 211 are provided on the power reception device side. However, in a case of performing wireless communication, their provided locations are not particularly limited.

It is also possible to perform communication using the power transmission device and the power reception device by causing the power transmission/reception device to transmit specific power. In this case, it is not necessary to separately provide the communication units 12, 13.

The control units 11, 211 and the abnormality detection units may be formed using integrated circuits such as FPGA, instead of microcomputers.

### INDUSTRIAL APPLICABILITY

The wireless power supply system according to the present invention is applicable as a power supply system that transmits power between a main power supply and a load not connected via a wire. The elevator according to the present invention is applicable as elevating means in a building.

### DESCRIPTION OF THE REFERENCE CHARACTERS

1 main power supply

2 inverter

3 power transmission coil unit

4 power transmission device

5 power reception coil unit

6 rectification circuit

7 power reception device

8 power transmission/reception device

9 load

10 lead wire

11 control unit

12 communication unit

13 communication unit

14 cable

30 power transmission coil

31 magnetic body

32 magnetic-shielding plate

50 power reception coil

51 magnetic body

52 magnetic-shielding plate

100 wireless power supply system

110 processor

111 memory

112 storage device

113 interface

114 data bus

200 wireless power supply system

202 inverter

204 power transmission device

206 rectification circuit

207 power reception device

208 power transmission/reception device

211 control unit

213 power transmission device abnormality detection unit

215 power reception device detection unit

300 wireless power supply system

304 power transmission device

307 power reception device

312 power reception unit

313 power transmission unit

320 elevator

321 car

322 hoistway

401 main power supply

402 AC/DC converter

1.-12. (canceled)

13. An elevator comprising:
a car having a load;
a hoistway through which the car moves up/down;
a plurality of power transmissions provided for an entirety of the hoistway and provided one by one at each of a plurality of stop floors which are stop positions of the car, so as to correspond to the respective stop floors; and
a plurality of power reception devices provided to the car and connected in parallel to the load, wherein
each of the power transmissions includes at least one power transmission device,
each of the power transmission devices includes a power transmission coil connected to a main power supply, and an inverter which is provided between the main power supply and the power transmission coil, and which converts power supplied from the main power supply, to power having a predetermined frequency, and supplies the power to the power transmission coil,
each of the power reception devices includes a power reception coil for receiving power transmitted from any of the power transmission coils and supplying power to the load,
the power transmission coil of the power transmission device of each power transmission is provided so as to be opposed to at least one of the power reception coils of the plurality of power reception devices when the car stops at the corresponding stop floor, and
power at which power transmission efficiency is maximized in each power transmission is set on the basis of a power requirement of the load at the corresponding stop floor.

14. The elevator according to claim 13, wherein
the plurality of stop floors include a principal floor and another floor,
a power requirement at the principal floor is greater than a power requirement at the other floor, and
power at which power transmission efficiency is maximized in the power transmission provided so as to correspond to the principal floor is greater than power at which power transmission efficiency is maximized in the power transmission provided so as to correspond to the other floor.

15. The elevator according to claim 14, wherein
a number of the power transmission devices included in the power transmission provided so as to correspond to the principal floor is equal to a number of the power reception devices provided to the car, and
a number of the power transmission devices included in the power transmission provided so as to correspond to the other floor is smaller than a number of the power reception devices provided to the car.

16. The elevator according to claim 14, wherein a door opened period of the car is longer at the principal floor than at the other floor.

17. The elevator according to claim 13, wherein
at least one of the plurality of power transmissions includes a plurality of the power transmission devices,
the plurality of power reception devices, and the plurality of power transmission devices included in any of the power transmissions, form a plurality of power transmission/reception devices,
each of the power transmission/reception devices is composed of one of the power reception devices and one of the power transmission devices, and
the plurality of power transmission/reception devices include at least two types of power transmission/reception devices that are different in power at which power transmission efficiency is maximized.

18. The elevator according to claim 13, wherein
at least one of the plurality of power transmissions includes a plurality of the power transmission devices,
the plurality of power reception devices, and the plurality of power transmission devices included in any of the power transmissions, form a plurality of power transmission/reception devices,
each of the power transmission/reception devices is composed of one of the power reception devices and one of the power transmission devices, and
the plurality of power transmission/reception devices are equal in power at which power transmission efficiency is maximized.

19. The elevator according to claim 13, wherein
at least one of the plurality of power transmissions includes a plurality of the power transmission devices,
the plurality of power reception devices, and the plurality of power transmission devices included in any of the power transmissions, form a plurality of power transmission/reception devices,
each of the power transmission/reception devices is composed of one of the power reception devices and one of the power transmission devices, and
the plurality of power transmission/reception devices include one power transmission/reception device of which power at which power transmission efficiency is maximized is equal to an average power requirement of the load, or at least two power transmission/reception devices of which a sum of powers at which power transmission efficiencies are maximized is equal to an average power requirement of the load.

20. The elevator according to claims 13, wherein
at least one of the plurality of power transmissions includes a plurality of the power transmission devices,
the plurality of power reception devices, and the plurality of power transmission devices included in any of the power transmissions, form a plurality of power transmission/reception devices, and
each of the power transmission/reception devices is composed of one of the power reception devices and one of the power transmission devices,
the elevator further comprising a controller which, when one power transmission/reception device of which power at which power transmission efficiency is maximized is not less than a power requirement of the load or at least two power transmission/reception devices of which a sum of powers at which power transmission efficiencies are maximized is not less than a power requirement of the load constitute some of the plurality of power transmission/reception devices, causes the one or at least two power transmission/reception devices constituting some of the plurality of power transmission/reception devices, to transmit power, and does not cause the rest of the power transmission/reception devices to transmit power.

21. The elevator according to claim 20, wherein
the controller determines the power requirement of the load on the basis of a current value or a voltage value of the load.

22. The elevator according to claim 13, wherein
at least one of the plurality of power transmissions includes a plurality of the power transmission devices,
the plurality of power reception devices, and the plurality of power transmission devices included in any of the power transmission, form a plurality of power transmission/reception devices,
each of the power transmission/reception devices is composed of one of the power reception devices and one of the power transmission devices,
the plurality of power transmission/reception devices each include
a power transmission switch provided between the main power supply and the inverter,
a power reception switch provided between the load and the power reception coil, and
an abnormality detector for detecting abnormality of the power transmission/reception device, and
the abnormality detector turns off the power transmission switch and the power reception switch, when having detected abnormality.

23. The elevator according to claim 22, further comprising a controller which, when one power transmission/reception device of which power at which power transmission efficiency is maximized is not less than a power requirement of the load or at least two power transmission/reception devices of which a sum of powers at which power transmission efficiencies are maximized is not less than a power requirement of the load constitute some of the plurality of power transmission/reception devices, causes the one or at least two power transmission/reception devices constituting some of the plurality of power transmission/reception devices, to transmit power, and does not cause the rest of the power transmission/reception devices to transmit power, wherein
the one or at least two power transmission/reception devices constituting some of the plurality of power transmission/reception devices are the power transmission/reception devices for which the abnormality detectors have not detected abnormality.

24. An elevator comprising:
a car;
a hoistway through which the car moves up/down; and
a wireless power supply system, wherein
the wireless power supply system includes a plurality of power transmission/reception devices, the power transmission/reception devices each including
a power transmission coil connected to a main power supply,
a power reception coil for receiving power transmitted from the power transmission coil and supplying power to a load, and
an inverter which is provided between the main power supply and the power transmission coil, and which converts power supplied from the main power supply, to power having a predetermined frequency, and supplies the power to the power transmission coil,
the plurality of power transmission/reception devices are connected in parallel between the main power supply and the load, and
the wireless power supply system is provided at each of at least two stop positions of the car so that a plurality of the power reception coils provided to the car and a plurality of the power transmission coils provided to the hoistway are opposed to each other,
the elevator further comprising a controller for performing control so that power to be transmitted becomes smaller at a stop position where a door opened period of the car is shorter, of the at least two stop positions.
